(19) United States
(12) Patent Application Publication
(10) Pub. No.: US 2016/0358693 A1
(43) Pub. Date: Dec. 8, 2016

(54) Class 1E cable for third generation passive nuclear power plant in mild environment and manufacturing method thereof

(71) Applicant: SHANDONG HUALING GABLE CO.LTD., Jinan (CN)

(72) Inventors: Zhaobo Wang, Jinan (CN); Maolong Pan, Jinan (CN); Huaixu Song, Jinan (CN); Guangjie Li, Jinan (CN); Xiaoyu Li, Jinan (CN); Menggang Zhai, Jinan (CN)

(73) Assignee: SHANDONG HUALING GABLE CO.LTD.

(21) Appl. No.: 14/550,306

(22) Filed: Nov. 21, 2014

(30) Foreign Application Priority Data
Aug. 26, 2014 (CN) 201410424852.3

(51) Int. Cl. H01B 9/02; H01B 13/14

(52) U.S. Cl. CPC H01B 9/02; H01B 13/141

(57) ABSTRACT

A class 1E cable for a third generation passive nuclear power plant in a mild environment, comprising: at least one conductor; wherein an heterogeneous double-layer co-extrusion insulator is extruded on an external wall of the conductor, a wrapping tape is wrapped around the heterogeneous double-layer co-extrusion insulator to form a wire core, and the wire core is provided in a filler; a shielding layer 6, an oxygen barrier layer an inner protection jacket layer, and an outer protection jacket layer are wrapped around the filler; the heterogeneous double-layer co-extrusion insulator comprises an inner insulating layer and an outer insulating layer, wherein the inner insulating layer and the outer insulating layer are made of different materials; and the inner protection jacket layer and the outer protection jacket layer are made of different materials.

### BACKGROUND OF THE PRESENT INVENTION

Field of Invention

The present invention relates to a method for manufacturing a cable, and more particularly to a class 1E cable for a third generation passive nuclear power plant in a mild environment and a manufacturing method therefor.

Description of Related Arts

In the twenty-first century, the population and economic growth in developing countries brings massively increased requirements for energy sources. Furthermore, fuels which provide over 80% of the current electricity are gradually depleted. In addition, due to environmental requirements, utilization of the fuels is restricted to a large extent. From aspects of protecting resource, improving environmental quality and reliably supplying energy resource, nuclear power has apparent disadvantages.

In the special utilization environment of a nuclear power plant, cables matching with the nuclear power plant must have characteristics of: high thermal stability, high chemical stability, high irradiation resistance, high aging resistance, damp resistance, corrosion resistance, low smoke, zero halogen, flame retardancy, long service life and etc. At the present stage of China, high-end products of nuclear cables mainly depend on importation, and only part of the nuclear cables is domestic.

At present, in fields of cables for utilizing in a third generation passive nuclear power plant, after searching, a class 1E cable for the third generation passive nuclear power plant in a mild environment, which has an insulating layer and a jacket made of polyolefin materials, is not found in China.

### SUMMARY OF THE PRESENT INVENTION

In order to overcome the above-mentioned performance defects of a class 1E cable for a third generation passive nuclear power plant in a mild environment, such as low irradiation resistance and short service life, the present invention provides a class 1E cable for a third generation passive nuclear power plant in the mild environment and a manufacturing method therefor. Class 1E cables have characteristics of low smoke, zero halogen, flame retardancy, low toxicity, corrosion resistance, excellent electrical performances, high irradiation resistance, long service life and etc., and are capable of effectively satisfying utilization requirements of the class 1E cable for the third generation passive nuclear power plant in the mild environment.

Accordingly, in order to accomplish the above objects, the present invention adopts technical solutions as follows.

A class 1E cable for a third generation passive nuclear power plant in a mild environment, comprises: at least one conductor;

wherein a heterogeneous double-layer co-extrusion insulator is extruded on an external wall of the conductor, a wrapping tape is wrapped around the heterogeneous double-layer co-extrusion insulator to form a wire core, and the wire core is provided in a filler;

a shielding layer, an oxygen barrier layer, an inner protection jacket layer and an outer protection jacket layer are wrapped around the filler;

the heterogeneous double-layer co-extrusion insulator comprises an inner insulating layer and an outer insulating layer, wherein the inner insulating layer and the outer insulating layer are made of different materials; and

the inner protection jacket layer and the outer protection jacket layer are made of different materials.

Preferably, the inner protection jacket layer is made of zero halogen flame retardant polyolefin, and the outer protection jacket layer is made of low smoke zero halogen flame retardant polyolefin.

Preferably, the inner insulating layer is made of polyethylene and the outer layer is made of low smoke zero halogen cross-linked polyolefin.

Preferably, the shielding layer comprises an inner shielding layer and an outer shielding layer, the inner shielding layer is wrapped by a copper-plastic composite belt, and the outer shielding layer is weaved by a tinned copper wire.

Preferably, an armor layer is provided between the inner protection jacket layer and the outer protection jacket layer, and the armor layer is formed by lap wrapping a double-layer metal tape along an identical direction with a gap.

Preferably, the double-layer metal tape is a galvanized steel tape.

Preferably, two wire cores are wrapped together by a sub-shielding layer to form a combined body which is provided in the filler, and a plurality of combined bodies are wrapped together by a wrapping tape layer, wherein the shielding layer is wrapped around the wrapping tape layer.

A method for manufacturing the class 1E cable mentioned above, comprises following steps of:

selecting materials of the conductor-wrapping-extruding to form the inner insulating layer and the outer insulating layer-performing radiation cross-linking on the inner insulating layer and the outer insulating layer-cabling-extruding the filler-shielding-extruding the inner protection jacket layer or an oxygen barrier layer-extruding the outer protection jacket layer-performing radiation cross-linking on the outer protection jacket layer;

wherein a thickness ratio of the inner insulating layer to the outer insulating layer is 1:3;

extrusion of the inner insulating layer adopts a common screw, and extrusion of the outer insulating layer adopts a low compression ratio screw;

before the extrusion of the insulating layer, a conductor having a cross-sectional area below 10 mm² is pre-heated to a temperature at a range of 90-100° C., and insulating materials are heated to 60±5° C. for 1-2 hour;

during extrusion process, temperatures of the inner insulating layer is controlled at a range of 140-185 ° C., and temperatures of the outer insulating layer is controlled at a range of 90-175° C.;

wherein the wire core adopts a subsection cooling, in a first cooling section, temperatures of cooling water are at a range of 60-70° C. and in a second cooling section, temperatures of the cooling water are at a room temperature;

the outer protection jacket layer is extruded out via a semi-tubing extrusion mould on an extrusion unit by a low compression ratio screw, before extruding out, materials are pre-heated to 60±5° C. for 1-2 hour, and during the extrusion process temperatures of the materials are controlled at a range of 90-155° C.;

after the extrusion, subsection cooling is performed, in the first cooling section, temperatures of cooling water are at a range of 60-70° C.; and in the second cooling section, temperatures of the cooling water are at a room temperature;

during the extrusion process, temperatures of the inner protection jacket layer and the oxygen barrier layer are controlled at a range of 90-160° C.

Preferably, in the step of cabling, extruded zero halogen flame retardant polyolefin is filled in clearances, reticular rip cord made of aramid fiber or a compound of aramid fiber and polypropylene is provided in a center, and an external portion extrudes out zero halogen flame retardant polyolefin.

Preferably, the conductor is made of stranded tinned copper, a stranding lay length of the conductor is 13-20 times of a diameter of the conductor, an outmost layer has a left lay direction and adjacent layers have opposite lay directions; and

an overlap ratio of the wrapping tape made of polyester is controlled at a range of 15%˜20%.

Beneficial effects of the present invention are: utilization convenience, low cost, strong resistance to interference, good weather resistance, operation stability and reliability and a service life of over 60 years.

These and other objectives, features, and advantages of the present invention will become apparent from the following detailed description, the accompanying drawings, and the appended claims.

### BRIEF DESCRIPTION OF THE DRAWINGS

FIG. 1 is a structurally schematic view of a first class 1E cable for a third generation passive nuclear power plant in a mild environment according to a first preferred embodiment of the present invention.

FIG. 2 is a structurally schematic view of a second class 1E cable for the third generation passive nuclear power plant in the mild environment according to a second preferred embodiment of the present invention.

FIG. 3 is a structurally schematic view of a third class 1E cable for the third generation passive nuclear power plant in the mild environment according to a second preferred embodiment of the present invention.

Reference numbers in the Figs.: 1—conductor; 2—inner insulating layer; 3—outer insulating layer; 4—wrapping tape; 5—filler; 6—shielding layer; 7—inner protection jacket layer; 8—outer protection jacket layer; 9—armor layer; 10—sub-shielding layer; 11—wrapping tape layer.

### DETAILED DESCRIPTION OF THE PREFERRED EMBODIMENT

One skilled in the art will understand that the embodiment of the present invention as shown in the drawings and described above is exemplary only and not intended to be limiting.

### Embodiment 1

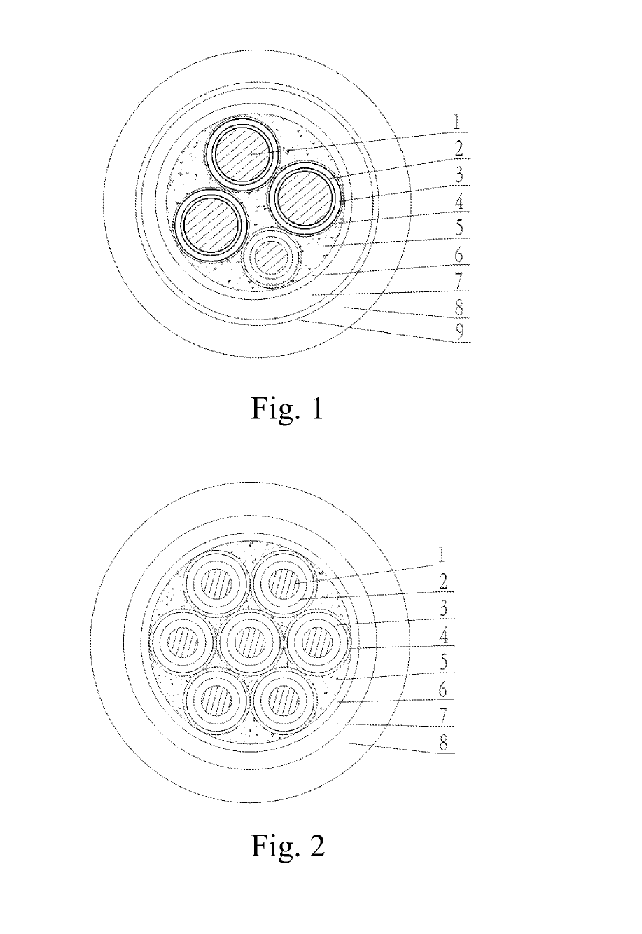

Referring to FIG. 1 of the drawings, according to a first preferred embodiment of the present invention, a power cable for a third generation passive nuclear power plant in a mild environment, comprises: four conductors 1;

wherein a heterogeneous double-layer co-extrusion insulator is extruded on an external wall of the conductor, a wrapping tape 4 is wrapped around the heterogeneous double-layer co-extrusion insulator to form a wire core, and the wire core is provided in a filler 5;

a shielding layer 6, an inner protection jacket layer 7, an armor layer 9 and an outer protection jacket layer 8 are wrapped around the filler 5 in sequence;

the shielding layer 6 comprises an inner shielding layer and an outer shielding layer, the inner shielding layer is wrapped by a copper-plastic composite belt, and the outer shielding layer is weaved by a tinned copper wire;

the heterogeneous double-layer co-extrusion insulator comprises an inner insulating layer 2 and an outer insulating layer 3, wherein the inner insulating layer 2 and the outer insulating layer 3 are made of different materials, the inner insulating layer 2 is made of polyethylene, and the outer layer 3 is made of low smoke zero halogen cross-linked polyolefin;

the armor layer 9 is formed by lap wrapping a double-layer metal tape along an identical direction with a gap, and the metal tape is a galvanized steel tape; and

the inner protection jacket layer 7 and the outer protection jacket layer 8 are made of different materials, wherein the inner protection jacket layer 7 is made of zero halogen flame retardant polyolefin, and the outer protection jacket layer 8 is made of low smoke zero halogen flame retardant polyolefin.

A method for manufacturing the power cable mentioned above, comprises following steps of:

selecting materials of the conductor-wrapping-extruding to form the inner insulating layer 2 and the outer insulating layer 3—performing radiation cross-linking on the inner insulating layer 2 and the outer insulating layer 3—cabling-extruding the filler-shielding-extruding the inner protection jacket layer 7 or an oxygen barrier layer-extruding the outer protection jacket layer 8—performing radiation cross-linking on the outer protection jacket layer 8.

Specifically, the steps are further illustrated step-by-step as follows.

### Selecting Materials of the Conductor

Select stranded tinned copper as a material for the conductor. The conductor is in a standard stranded circular shape, and a stranding lay length thereof is 13-20 times of a diameter of the conductor. An outmost layer has a left lay direction. Adjacent layers have opposite lay directions.

### Wrapping

The wrapping tape 4 is a tape made of polyester, and an overlap ratio thereof is controlled at a range of 15%˜20%.

### Extruding the Inner Insulating Layer and the Outer Insulating Layer

Double-layer co-extrusion is performed on the inner insulating layer and the outer insulating layer. A thickness ratio of the inner insulating layer to the outer insulating layer is 1:3. Extrusion of the inner insulating layer adopts a common screw, and extrusion of the outer insulating layer adopts a low compression ratio screw. Before the extrusion of the insulating layer, a conductor having a cross-sectional area below 10 mm² is pre-heated to a temperature at a range of 90-100° C. Insulating materials are heated to 60±5° C. for 1-2 hour. The wire core adopts a subsection cooling. In a first cooling section, temperatures of cooling water are at a range of 60-70° C. In a second cooling section, temperatures of the cooling water are at a room temperature. The outer protection jacket layer 8 is extruded out via a semi-tubing extrusion mould on an extrusion unit by a low compression ratio screw. Before extruding out, materials are pre-heated to 60±5° C. for 1-2 hour. After extruding out, the materials are performed with subsection cooling. In the first cooling section, temperatures of cooling water are at a range of 60-70° C. In the second cooling section, temperatures of the cooling water are at a room temperature.

Reference temperatures in the extrusion are as follows, and the temperatures can be adjusted according to actual situation.

| | Temperature | First | Second | Third | Fourth | | | Die |
|---|---|---|---|---|---|---|---|---|
| Location | Tolerance | zone | zone | zone | zone | Flange | Head | orifice |
| Inner | ±10° C. | 140 | 165 | 175 | 180 | 170 | 180 | 185 |
| insulating | | | | | | | | |
| layer | | | | | | | | |
| Outer | ±10° C. | 90 | 160 | 165 | 170 | 165 | 170 | 175 |
| insulating | | | | | | | | |
| layer | | | | | | | | |

### Performing Radiation Cross-linking on the Inner Insulating Layer and the Outer Insulating Layer

Perform radiation cross-linking on the inner insulating layer and the outer insulating layer, wherein a loaded elongation is at a range of 50%-100%.

### Cabling

An outmost layer has a right cabling direction. Adjacent layers have opposite cabling directions. In the first preferred embodiment, a laying up pitch is 30-40 times of a diameter of a laying up diameter. Extruded zero halogen flame retardant polyolefin is filled in clearances. Reticular rip cord made of aramid fiber, or a compound of aramid fiber and polypropylene is provided in a center, and an external portion is extruded out zero halogen flame retardant polyolefin.

Reference temperatures in the extrusion are as follows, and the temperatures can be adjusted according to actual situation.

| | First | Second | Third | Fourth | | | Die |
|---|---|---|---|---|---|---|---|
| Location | zone | zone | zone | zone | Flange | Head | orifice |
| Temperature | 90-100 | 100-110 | 110-120 | 120-130 | 120-130 | 140-150 | 150-160 |
| (° C.) | | | | | | | |

### Shielding

The shielding adopts a composite shielding structure. The inner shielding layer adopts a vertical wrapped copper-plastic composite belt, an overlap ratio is at a range of 15%-20%. A tinned copper drainage wire with a nominal cross section area of 0.5 mm² is provided below the copper-plastic composite belt. The outer shielding layer adopts braided shielding, and a material thereof is a tinned copper wire. Shielding layers of the vertical wrapped copper-plastic composite belt and the braided shielding tinned copper wire are manufactured simultaneously.

### Extruding the Inner Protection Jacket Layer or the Oxygen Barrier Layer

Perform drying on materials before extrusion, extrude out by a low compression ratio screw. The filler is extruded out in an extrusion manner When the filler is extruding out, an aperture of a screen plate, i.e., a grading ring, is at a range of 9-15 mm, so as to reduce extrusion pressures.

Reference extrusion temperatures are as follows, and the temperatures can be adjusted according to actual situation.

| | First | Second | Third | Fourth | | | Die |
|---|---|---|---|---|---|---|---|
| Location | zone | zone | zone | zone | Flange | Head | orifice |
| Temperature | 90-100 | 100-110 | 110-120 | 120-130 | 120-130 | 140-150 | 150-160 |
| (° C.) | | | | | | | |

### Extruding the Outer Protection Jacket Layer

The outer protection jacket layer is extruded out via a semi-tubing extrusion mould on an extrusion unit by a low compression ratio screw. Before extruding out, materials are pre-heated to 60±5° C. for 1-2 hour. After extruding out, the materials are performed with subsection cooling. In the first cooling section, temperatures of cooling water are at a range of 60-70° C. In the second cooling section, temperatures of the cooling water are at a room temperature.

| | First | Second | Third | Fourth | | | Die |
|---|---|---|---|---|---|---|---|
| Location | zone | zone | zone | zone | Flange | Head | orifice |
| Temperature | 90 | 140 | 145 | 150 | 145 | 150 | 155 |
| Tolerance | | | | | | | |
| (±10° C.) | | | | | | | |

### Embodiment 2

Referring to FIG. 2 of the drawings, according to a second preferred embodiment of the present invention, a control cable for a third generation passive nuclear power plant in a mild environment, comprises: seven conductors 1;

wherein a heterogeneous double-layer co-extrusion insulator is extruded on an external wall of the conductor, a wrapping tape 4 is wrapped around the heterogeneous double-layer co-extrusion insulator to form a wire core, and the wire core is provided in a filler 5;

a shielding layer 6, an inner protection jacket layer 7, and an outer protection jacket layer 8 are wrapped around the filler 5 in sequence;

the shielding layer 6 comprises an inner shielding layer and an outer shielding layer, the inner shielding layer is wrapped by a copper-plastic composite belt, and the outer shielding layer is weaved by a tinned copper wire;

the heterogeneous double-layer co-extrusion insulator comprises an inner insulating layer 2 and an outer insulating layer 3, wherein the inner insulating layer 2 and the outer insulating layer 3 are made of different materials, the inner insulating layer 2 is made of polyethylene, and the outer layer 3 is made of low smoke zero halogen cross-linked polyolefin; and

the inner protection jacket layer 7 and the outer protection jacket layer 8 are made of different materials, wherein the inner protection jacket layer 7 is made of zero halogen flame retardant polyolefin, and the outer protection jacket layer 8 is made of low smoke zero halogen flame retardant polyolefin.

### Embodiment 3

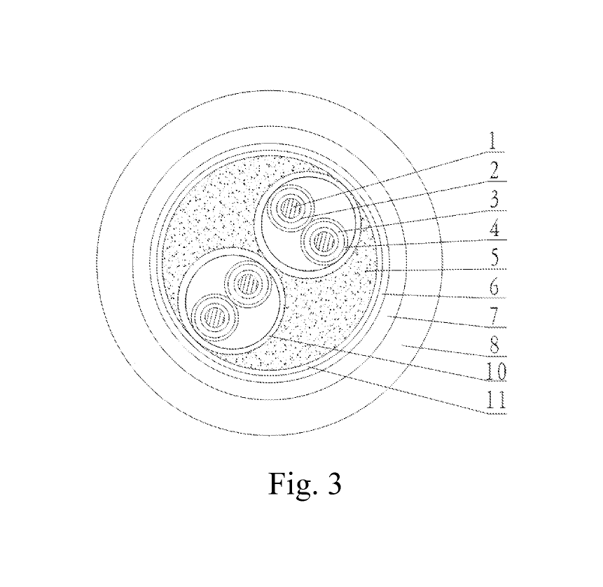

Referring to FIG. 3 of the drawings, according to a third preferred embodiment of the present invention, an instrument cable for a third generation passive nuclear power plant in a mild environment, comprises: four conductors 1;

wherein a heterogeneous double-layer co-extrusion insulator is extruded on an external wall of the conductor, a wrapping tape 4 is wrapped around the heterogeneous double-layer co-extrusion insulator to form wire cores, two of the wire core are wrapped together by a sub-shielding layer 10 to form a combined body to be provided in the filler 5, and a plurality of combined bodies are wrapped together by a wrapping tape layer 11 and are provided in the filler 5;

a shielding layer 6, an inner protection jacket layer 7, and an outer protection jacket layer 8 are wrapped around the filler 5 in sequence;

the heterogeneous double-layer co-extrusion insulator comprises an inner insulating layer 2 and an outer insulating layer 3, wherein the inner insulating layer 2 and the outer insulating layer 3 are made of different materials, the inner insulating layer 2 is made of polyethylene, and the outer layer 3 is made of low smoke zero halogen cross-linked polyolefin;

the shielding layer 6 comprises an inner shielding layer and an outer shielding layer, the inner shielding layer is wrapped by a copper-plastic composite belt, and the outer shielding layer is weaved by a tinned copper wire;

the inner protection jacket layer 7 and the outer protection jacket layer 8 are made of different materials, wherein the inner protection jacket layer 7 is made of zero halogen flame retardant polyolefin, and the outer protection jacket layer 8 is made of low smoke zero halogen flame retardant polyolefin.

After testing, each of the cables in the preferred embodiment above has properties as follows.

The cables have good mechanical properties before and after aging. Before aging, a minimum value of tensile strength of the cables reaches 10.0 N/mm², and a minimum value of breaking elongation thereof reaches 200%. After aging, rate of change of the tensile strength and the breaking elongation of the cables is not exceeding ±25%. In an insulated thermal elongation test, a maximum value of elongation under load is not exceeding 175%. After cooling, a maximum value of a permanent deformation elongation is 15%.

Before aging, the jacket has following properties. A minimum value of tensile strength of the jacket reaches 9.0 N/mm², and a minimum value of breaking elongation thereof reaches 125%. After aging, rate of change of the tensile strength and the breaking elongation of the cables is not exceeding ±40%. In an insulated thermal elongation test, a maximum value of elongation under load is not exceeding 175%. After cooling, a maximum value of a permanent deformation elongation is 15%.

The cables in the preferred embodiments mentioned above are performed with a thermal aging simulation test under normal condition, and a thermal accelerating aging test equivalent to operating for 60 years, and the mechanical properties of the insulating layer and the jacket are capable of meeting the requirements.

Finished cables and insulated wire cores thereof are firstly performed with thermal aging and radiation aging, and then with accidental irradiation, chemical spray, and test and simulation of working conditions of curves of temperature and pressure under a design basis accident (DBA). Insulated wire core taken out from a whole cable is performed with the accident test as well, so as to improve properties of insulated conductors under a condition without the inner protection jacket layer on a shell of the device. After the accident test, the whole cable and the insulated wire core bend around a reel having a diameter which is 40 times of the diameter of the cable to form a coil. The coil is performed with corresponding pressure test, and meets the requirement that under conditions of AC 3150 V/mm for 5 min, the cable is not breakdown.

After the accident test, another part of samples of the cables is put in a test container to be soaked in water for one year, the result shows that in the whole test, the jacket maintains integrity.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A class 1E cable for a third generation passive nuclear power plant in a mild environment, comprising: at least one conductor;
wherein a heterogeneous double-layer co-extrusion insulator is extruded on an external wall of the conductor, a wrapping tape is wrapped around the heterogeneous double-layer co-extrusion insulator to form a wire core, and the wire core is provided in a filler;
a shielding layer, an oxygen barrier layer, an inner protection jacket layer and an outer protection jacket layer are wrapped around the filler;
the heterogeneous double-layer co-extrusion insulator comprises an inner insulating layer and an outer insulating layer, wherein the inner insulating layer and the outer insulating layer are made of different materials; and
the inner protection jacket layer and the outer protection jacket layer are made of different materials.

2. The class 1E cable, as recited in claim 1, wherein the inner protection jacket layer is made of zero halogen flame retardant polyolefin, and the outer protection jacket layer is made of low smoke zero halogen flame retardant polyolefin.

3. The class 1E cable, as recited in claim 1, wherein the inner insulating layer is made of polyethylene and the outer layer is made of low smoke zero halogen cross-linked polyolefin.

4. The class 1E cable, as recited in claim 1, wherein the shielding layer comprises an inner shielding layer and an outer shielding layer, the inner shielding layer is wrapped by a copper-plastic composite belt, and the outer shielding layer is weaved by a tinned copper wire.

5. The class 1E cable, as recited in claim 1, wherein an armor layer is provided between the inner protection jacket layer and the outer protection jacket layer, and the armor layer is formed by lap wrapping a double-layer metal tape along an identical direction with a gap.

6. The class 1E cable, as recited in claim 2, wherein an armor layer is provided between the inner protection jacket layer and the outer protection jacket layer, and the armor layer is formed by lap wrapping a double-layer metal tape along an identical direction with a gap.

7. The class 1E cable, as recited in claim 3, wherein an armor layer is provided between the inner protection jacket layer and the outer protection jacket layer, and the armor layer is formed by lap wrapping a double-layer metal tape along an identical direction with a gap.

8. The class 1E cable, as recited in claim 4, wherein an armor layer is provided between the inner protection jacket layer and the outer protection jacket layer, and the armor layer is formed by lap wrapping a double-layer metal tape along an identical direction with a gap.

9. The class 1E cable, as recited in claim 5, wherein the double-layer metal tape is a galvanized steel tape.

10. The class 1E cable, as recited in claim 6, wherein the double-layer metal tape is a galvanized steel tape.

11. The class 1E cable, as recited in claim 7, wherein the double-layer metal tape is a galvanized steel tape.

12. The class 1E cable, as recited in claim 8, wherein the double-layer metal tape is a galvanized steel tape.

13. The class 1E cable, as recited in claim 1, wherein two wire cores are wrapped together by a sub-shielding layer to form a combined body which is provided in the filler, and a plurality of combined bodies are wrapped together by a wrapping tape layer, wherein the shielding layer is wrapped around the wrapping tape layer.

14. The class 1E cable, as recited in claim 2, wherein two wire cores are wrapped together by a sub-shielding layer to form a combined body which is provided in the filler, and a plurality of combined bodies are wrapped together by a wrapping tape layer, wherein the shielding layer is wrapped around the wrapping tape layer.

15. The class 1E cable, as recited in claim 3, wherein two wire cores are wrapped together by a sub-shielding layer to form a combined body which is provided in the filler, and a plurality of combined bodies are wrapped together by a wrapping tape layer, wherein the shielding layer is wrapped around the wrapping tape layer.

16. The class 1E cable, as recited in claim 4, wherein two wire cores are wrapped together by a sub-shielding layer to form a combined body which is provided in the filler, and a plurality of combined bodies are wrapped together by a wrapping tape layer, wherein the shielding layer is wrapped around the wrapping tape layer.

17. A method for manufacturing a class 1E cable, comprising following steps of:
selecting materials of a conductor-wrapping-extruding to form an inner insulating layer and an outer insulating layer-performing radiation cross-linking on the inner insulating layer and the outer insulating layer-cabling-extruding a filler-shielding-extruding an inner protection jacket layer or an oxygen barrier layer-extruding an outer protection jacket layer-performing radiation cross-linking on the outer protection jacket layer;
wherein a thickness ratio of the inner insulating layer to the outer insulating layer is 1:3;
extrusion of the inner insulating layer adopts a common screw, and extrusion of the outer insulating layer adopts a low compression ratio screw;
before the extrusion of the inner insulating layer and the outer insulating layer, a conductor having a cross-sectional area below 10 mm² is pre-heated to a temperature at a range of 90-100° C., and insulating materials are heated to 60±5° C. for 1-2 hour;
during extrusion process, temperatures of the inner insulating layer is controlled at a range of 140-185° C., and temperatures of the outer insulating layer is controlled at a range of 90-175° C.;
wherein a wire core adopts a subsection cooling, in a first cooling section, temperatures of cooling water are at a range of 60-70° C. and in a second cooling section, temperatures of the cooling water are at a room temperature;
the outer protection jacket layer is extruded out via a semi-tubing extrusion mould on an extrusion unit by a low compression ratio screw, before extruding out, materials are pre-heated to 60±5° C. for 1-2 hour, and during the extrusion process temperatures of the materials are controlled at a range of 90-155° C.;
after the extrusion, subsection cooling is performed, in the first cooling section, temperatures of cooling water are at a range of 60-70° C.; and in the second cooling section, temperatures of the cooling water are at a room temperature;
during the extrusion process, temperatures of the inner protection jacket layer and the oxygen barrier layer are controlled at a range of 90-160° C.

18. The method for manufacturing the class 1E cable, as recited in claim 17, wherein in the step of cabling, extruded zero halogen flame retardant polyolefin is filled in clearances, reticular rip cord made of aramid fiber or a compound of aramid fiber and polypropylene is provided in a center, and an external portion extrudes out zero halogen flame retardant polyolefin.

19. The method for manufacturing the class 1E cable, as recited in claim 17, wherein the conductor is made of stranded tinned copper, a stranding lay length of the conductor is 13-20 times of a diameter of the conductor, an outmost layer has a left lay direction and adjacent layers have opposite lay directions; and an overlap ratio of the wrapping tape made of polyester is controlled at a range of 15%˜20%.

20. The method for manufacturing the class 1E cable, as recited in claim 18, wherein the conductor is made of stranded tinned copper, a stranding lay length of the conductor is 13-20 times of a diameter of the conductor, an outmost layer has a left lay direction and adjacent layers have opposite lay directions; and an overlap ratio of the wrapping tape made of polyester is controlled at a range of 15%˜20%.
